(19) United States
(12) Patent Application Publication
(10) Pub. No.: US 2004/0255666 A1
(43) Pub. Date: Dec. 23, 2004

(54) Thermocouple device and method of thermocouple construction employing small grain size conductors

(75) Inventor: Sun Park, Woburn, MA (US)

Correspondence Address: HAYES, SOLOWAY P.C., 130 W. CUSHING STREET, TUCSON, AZ, 85701, US

(73) Assignee: AMETEK, INC.

(21) Appl. No.: 10/465,336

(22) Filed: Jun. 19, 2003

(51) Int. Cl. G01F 1/68

(52) U.S. Cl. 73/204.24

(57) ABSTRACT

A temperature measuring device comprises a thermocouple junction having a plurality of conductors and a length of cable having at least one conductor coupling to at least one of the conductors of the thermocouple junction, wherein at least one the conductor in the length of cable comprises an iron, copper, constantan, or nickel-based alloy material having a grain size number of four or greater, measured by a grain size method defined by ASTM E112. The use of such a small grain size prevents fracture of the conductors. The length of cable may comprise mineral insulated cable, and the conductors in the length of cable may be of type K or type N. A method of measuring temperature consistent with the invention comprises connecting a length of cable having at least one conductor to at least one of the conductors of a thermocouple junction, wherein at least one the conductor in the length of cable comprises an iron, copper, constantan, or nickel-based alloy material having a grain size number of four or greater, measured by a grain size method defined by ASTM E112.

### BACKGROUND OF THE INVENTION

The present invention relates generally to temperature measurement technology, and more particularly, to a thermocouple probe assembly. Particular utility for the present invention is found in temperature measurements for aerospace and gas turbines with frequent thermal cycling, e.g., from repeated take-off and landing of a jet aircraft, or a power plant cycling between on during the day and off during the night.

A thermocouple probe assembly uses mineral insulated (“MI”) cable or cable segments for connection to the thermocouple junction. FIG. 1 shows a longitudinal cross section of a conductor of a standard thermocouple. It is noted that many of the grain boundaries visible in FIG. 1 are as large as the conductor's diameter. The grain size number of the cable segment illustrated in FIG. 1, measured according to ASTM E112, is zero.

ASTM E112 provides a standardized scale and method for measuring the average size of grain particles in a metal. A larger ASTM E112 number means a finer grain of particles in the metal. FIG. 2 shows two thermocouple conductors; the first conductor has an ASTM E112 grain size of seven and the second a grain size of five. It is noted that the average grain size is much smaller than in the conductor of FIG. 1.

In gas turbine engines, thermocouple probes must withstand high stress and strains caused by high temperatures and high levels of vibration. While the components to which a thermocouple is typically connected are not themselves exposed to high temperature or vibrations, conductors coupling these components to the thermocouple junction must handle these stresses and strains. These stresses may cause the conductors to break. This failure frequently occurs because of cracks along grain boundaries.

FIG. 3 shows a cross sectional view of a thermocouple probe following thermal cycle testing. The cable is a mineral insulated type K conductor. The circled region illustrates where the cable fractured during the thermal testing. FIG. 4 shows an enlarged view of the circled region with the arrow pointing to the crack. The crack occurred along the grain boundary, causing the failure of the probe. FIG. 5 shows a cross-sectional view of another cable segment following thermal cycle testing. The connection in this thermocouple conductor was completely cut by the fracture. FIG. 6 shows a longitudinal view of this failed conductor. This conductor failed because of cracks along the grain boundary. The arrows in FIG. 6 point to the cracks along the boundary, which run almost continuously through the conductor's diameter. The conductors in FIG. 3-6 all have an ASTM E112 number of zero to one.

Several solutions have been proposed for increasing the amount of time before a thermocouple conductor fractures and fails, including, e.g., keeping the thermocouple sheath in contact with the tubes of a furnace in which it is installed, or using duplex alloy sheath materials. Japanese Publication No. 11-223560 proposes mixing fine foreign articles to form a crystal nucleus during forming of the metallic wire in a platinum alloy-based (e.g., type S) thermocouple, but this solution only postpones, rather than prevents, eventual failure of the conductor. Additionally, platinum thermocouples are quite costly, and no suitable solution has been proposed for the problem of fracture in the more cost-effective type K and type N thermocouples.

### SUMMARY OF THE INVENTION

Accordingly, the present invention provides a thermocouple probe assembly that solves the foregoing problems of prior art thermocouples, and also solves other problems and has particular advantages not specifically disclosed herein. Furthermore, the present invention provides a thermocouple conductor that improves the reliability and performance of the device by preventing fracture of the conductor.

In one aspect, the present invention provides a temperature measuring device comprising a thermocouple junction having a plurality of conductors and a length of cable having at least one conductor coupling to at least one of the conductors of the thermocouple junction, wherein at least one the conductor in the length of cable comprises an iron, copper, constantan, or nickel-based alloy material having a grain size number of four or greater, measured by a grain size method defined by ASTM E112. The length of cable may comprise mineral insulated cable, and the conductors in the length of cable may be of type K or type N.

In another aspect, a method of measuring temperature consistent with the invention comprises connecting a length of cable having at least one conductor to at least one of the conductors of a thermocouple junction, wherein at least one the conductor in the length of cable comprises an iron, copper, constantan, or nickel-based alloy material having a grain size number of four or greater, measured by a grain size method defined by ASTM E112.

In a further aspect, a method of measuring temperature consistent with the invention comprises connecting a length of iron, copper, constantan, or nickel-based alloy conductor to at least one of the conductors of a thermocouple junction, wherein the average diameter of the grains of the length of conductor is selected to be less than half the diameter of the length of conductor.

In yet another aspect, a method of measuring temperature consistent with the invention comprises selecting an iron, copper, constantan, or nickel-based alloy conductor having a diameter greater than the average diameter of the grains of the length of nickel-based alloy conductor by a factor of at least two, and connecting the selected conductor to at least one of the conductors of a thermocouple junction.

In still another aspect, a method of manufacturing a conductor for a thermocouple, consistent with the invention, comprises selecting a length of iron, copper, constantan, or nickel-based alloy conductor based on a relationship between the diameter of the conductor and the average diameter of the grains of the length of nickel-based alloy conductor, and connecting the selected conductor to at least one of the conductors of a thermocouple junction.

In still a further aspect, a method of manufacturing a conductor for a thermocouple, consistent with the invention, comprises cold-working a length of iron, copper, constantan, or nickel-based alloy conductor by performing X number of draws upon the length of conductor, wherein X is an integer selected based on a relationship between the diameter of the conductor and the average diameter of the grains of the length of nickel-based alloy conductor.

In yet a further aspect, a method of manufacturing a conductor for a thermocouple, consistent with the invention, comprises brazing a length of iron, copper, constantan, or nickel-based alloy conductor for a time duration represented by a number X, wherein X is selected based on a relationship between the diameter of the conductor and the average diameter of the grains of the length of nickel-based alloy conductor.

### BRIEF DESCRIPTION OF THE DRAWINGS

FIG. 1 is an overall view of the longitudinal cross section of a conductor with a grain size according to ASTM E112 of zero, at 100× magnification;

FIG. 2 is an overall view of the longitudinal cross section of two conductors, wherein the conductor on the left has a grain size according to ASTM E112 of seven and the right conductor a grain size of five;

FIG. 3 depicts a cross sectional view of a thermocouple probe following thermal cycle testing, wherein the conductor is cable sheathed, mineral insulated type K conductor;

FIG. 4 is magnification of the circled region in FIG. 3, showing that the crack occurred along a grain boundary;

FIG. 5 is a cross section view of another conductor after thermal cycle failure;

FIG. 6 is a longitudinal view of another failed conductor having a grain size according to ASTM E112 of zero, at 100× magnification;

FIG. 7 depicts a side view of an exemplary thermocouple probe assembly consistent with the present invention;

FIG. 8 depicts a partial cross-sectional view of the exemplary thermocouple probe assembly of FIG. 1, taken along line AA-AA; and

FIG. 9 is a cross-sectional view of the exemplary thermocouple probe assembly of FIG. 1, taken along line BB-BB.

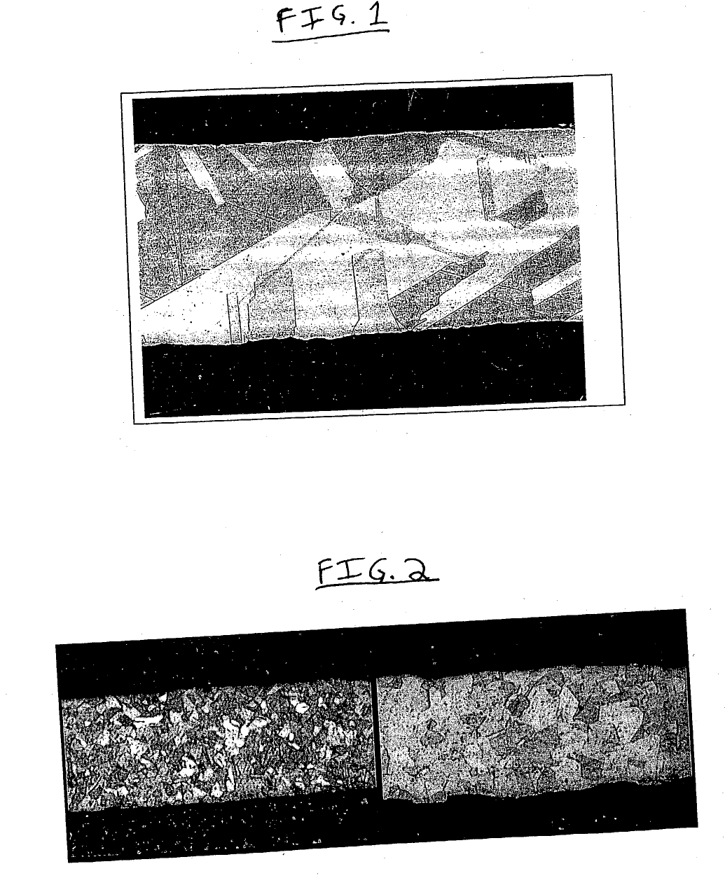

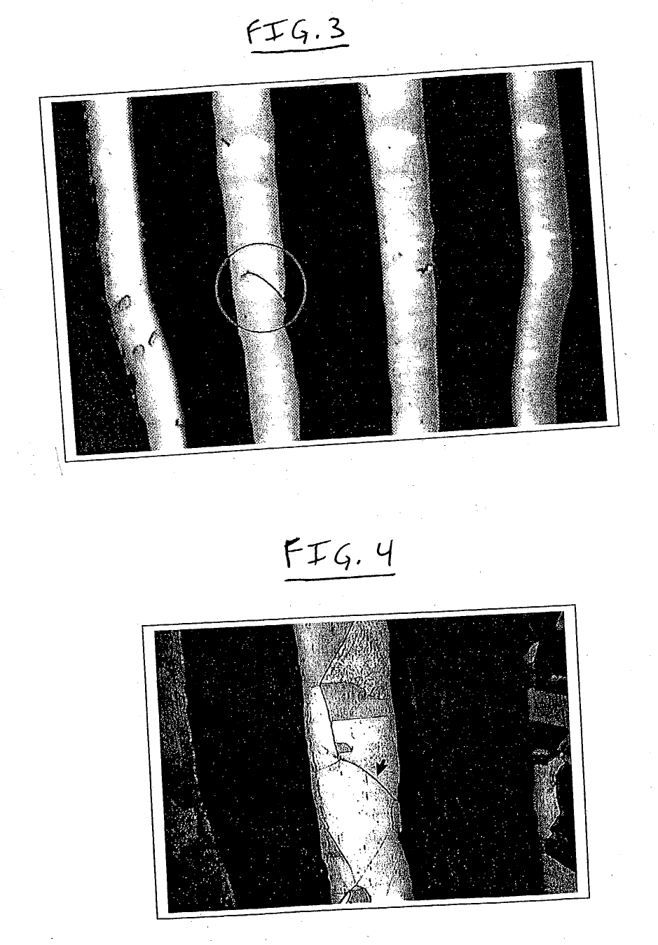

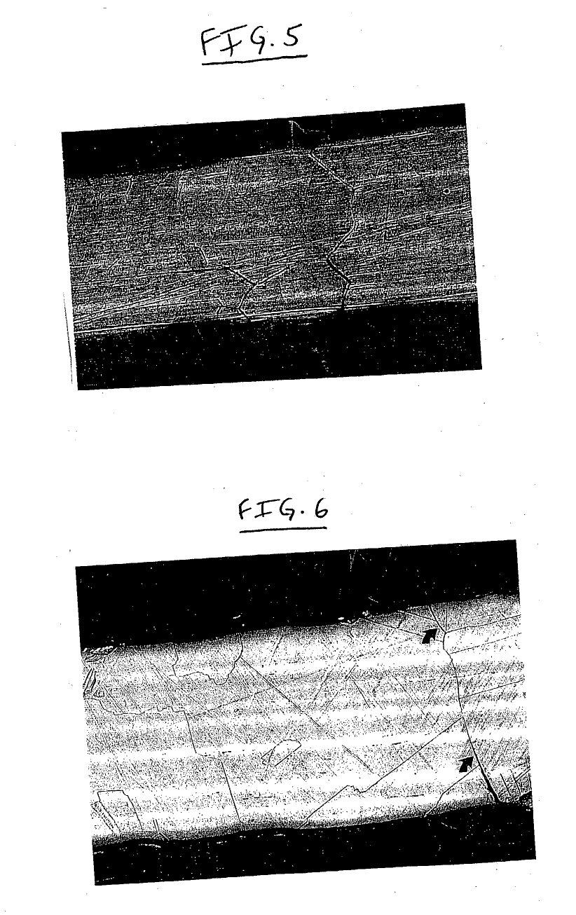

### DETAILED DESCRIPTION OF EXEMPLARY EMBODIMENTS

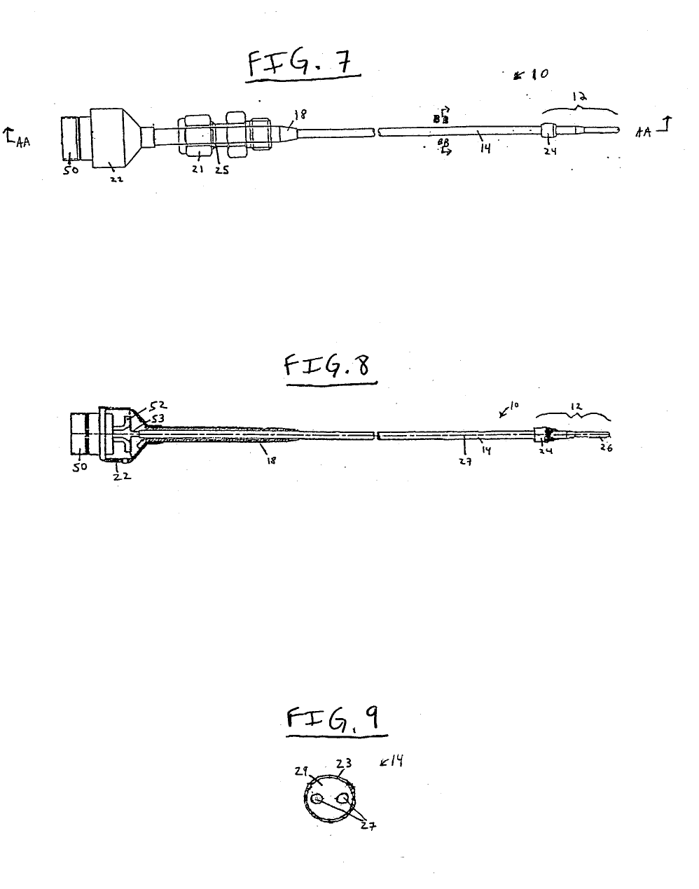

FIG. 7 depicts a side view of an exemplary thermocouple probe assembly 10 in one embodiment consistent with the present invention, FIG. 8 depicts a partial cross section of the thermocouple probe assembly 10 taken along line AA-AA, and FIG. 9 is a cross-sectional view of the exemplary thermocouple probe assembly of FIG. 7, taken along line BB-BB and illustrating a cross-section of the cable segment 14. With reference now to FIGS. 7, 8 and 9, the thermocouple probe assembly 10 of this exemplary embodiment comprises a thermocouple probe tip portion 12 that includes a thermocouple junction 26 coupled to a tapered bushing 24. The thermocouple probe tip 12 and bushing 24 are attached via a cable segment 14 to a backshell 22 via a protective tube 18 swaged onto the cable segment 14. The backshell 22 houses a plurality of bent contacts 52, each coupled both to a conductor 53 of the thermocouple (e.g., by welding) and to a corresponding pin (not shown) of a high temperature connector 50, e.g., a connector adapted to withstand high temperatures.

As shown in FIG. 9, the cable segment 14 comprises a plurality of conductors 27 insulated with a highly compressed refractory mineral insulation 29 (e.g., MgO) enclosed in a liquid-tight and gas-tight continuous metal sheath 23, e.g., an Inconel (trademark of Hoskins Manufacturing Co.) or stainless steel sheath.

The cable segment 14 comprises, e.g., type K or N mineral insulated cable, which has sufficient flexibility to resist breakage when the entire thermocouple probe assembly 10 is fixed at either end but stiff enough to allow the probe to be inserted into the protective tube 18. The conductors 27 are made of a metal, e.g., iron, copper, constantan, or nickel-based alloy, with a small grain size. Preferably, the conductors 27 have a grain size number measured according to ASTM E112 as equal to or greater than four. Improvements in the thermocouple's reliability, performance and the life span occur using smaller and more consistent grain size conductors. The small grain size will help minimize conductor fracturing along grain boundaries. A fracture along a grain boundary when using a small average grain size, e.g., ASTM E112 No. 4 or greater, is less likely to cause a break of the conductor as compared with conductors having larger average grain sizes, See, e.g., FIG. 2, wherein a fracture along a single grain boundary is unlikely to cause the conductor to break, due to the small size of the grains. In the present invention, the relationship between the diameter of the conductor and the average diameter of the grains of the length of the conductor (e.g., 2:1) is used to select a conductor that is less likely to fracture.

Using a smaller grain size also simplifies and shortens the manufacturing process of the thermocouple probes. Cold working and annealing is used to process mineral insulated cable. The more draws performed, the greater the opportunity for the grains to increase in size. Thus, the number of draws is minimized in the present invention to keep the grain size small. Consequently, the annealing time after each draw can also be reduced. Also, frequent thermal cycling of a conductor with small grains permits the conductor to stretch more, as opposed to cycle fatigue failures caused by fracture of brittle larger-grained conductors during elongation and compression. Additionally, thermocouples are often brazed to machine parts. Using small-grained conductor can decrease the braze cycle in some cases from twenty minutes to five minutes, which shortening is necessary to inhibit growth of the grains, since the longer the material is brazed in a furnace at a high temperature, the greater the opportunity for the grains to grow.

Thus, there has been provided a thermocouple probe assembly that provides high-temperature operability with improved reliability, performance and life, as detailed above. Those skilled in the art will recognize numerous modifications to the present invention, and all such modifications are deemed within the scope of the present invention, only as limited by the claims.

What is claimed is:

1. A temperature measuring device comprising:
a thermocouple junction having a plurality of conductors;
a length of cable having at least one conductor coupling to at least one of the conductors of said thermocouple junction;
wherein at least one said conductor in said length of cable comprises an iron, copper, constantan, or nickel-based alloy material having a grain size number of four or greater, measured by a grain size method defined by ASTM E112.

2. A temperature measuring device as claimed in claim 1, wherein said length of cable comprises mineral insulated cable.

3. A temperature measuring device as claimed in claim 1, wherein the conductors in said length of cable are of type K or type N.

4. A method of measuring temperature comprising:
connecting a length of cable having at least one conductor to at least one of the conductors of a thermocouple junction;
wherein at least one said conductor in said length of cable comprises an iron, copper, constantan, or nickel-based alloy material having a grain size number of four or greater, measured by a grain size method defined by ASTM E112.

5. A method of measuring temperature comprising:
connecting a length of iron, copper, constantan, or nickel-based alloy conductor to at least one of the conductors of a thermocouple junction;
wherein the average diameter of the grains of said length of conductor is selected to be less than half the diameter of conductor.

6. A method of measuring temperature comprising:
selecting an iron, copper, constantan, or nickel-based alloy conductor having a diameter greater than the average diameter of the grains of said length of nickel-based alloy conductor by a factor of at least two; and
connecting said selected conductor to at least one of the conductors of a thermocouple junction.

7. A method of manufacturing a conductor for a thermocouple comprising:
selecting a length of iron, copper, constantan, or nickel-based alloy conductor based on a relationship between the diameter of said conductor and the average diameter of the grains of said length of nickel-based alloy conductor; and
connecting said selected conductor to at least one of the conductors of a thermocouple junction.

8. A method of manufacturing a conductor for a thermocouple comprising:
cold-working a length of iron, copper, constantan, or nickel-based alloy conductor by performing X number of draws upon said length of conductor;
wherein X is an integer selected based on a relationship between the diameter of said conductor and the average diameter of the grains of said length of nickel-based alloy conductor.

9. A method of manufacturing a conductor for a thermocouple comprising:
brazing a length of iron, copper, constantan, or nickel-based alloy conductor for a time duration represented by a number X;
wherein X is selected based on a relationship between the diameter of said conductor and the average diameter of the grains of said length of nickel-based alloy conductor.
